(19) United States
(12) Patent Application Publication
(10) Pub. No.: US 2002/0140674 A1
(43) Pub. Date: Oct. 3, 2002

(54) Position/posture sensor or marker attachment apparatus

(75) Inventors: Yasuhiro Okuno, Tokyo (JP); Kenji Morita, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/093,515

(22) Filed: Mar. 11, 2002

(30) Foreign Application Priority Data
Mar. 13, 2001 (JP) 071119/2001

(51) Int. Cl. G09G 5/08

(52) U.S. Cl. 345/158; 340/686.1

(57) ABSTRACT

An attachment apparatus capable of attaching a position/posture sensor for detection of hand and a speaker, used in a virtual reality apparatus, a mixed reality apparatus and the like, to an observer's hand in a preferable state. The attachment apparatus has a structure where first ring 6 to which a position/posture sensor 2 is attached, a second ring 5 to which a speaker 1 is attached, and a band-shaped connection member 7 which connects the first and second rings with each other.

### FIELD OF THE INVENTION

The present invention relates to a technique for attachment of position/posture sensor used in an apparatus or system for providing an experience of virtual reality (VR) or mixed reality (MR) to an observer or player.

### BACKGROUND OF THE INVENTION

Conventionally, an apparatus and a system for providing an experience of virtual reality (VR) or mixed reality (MR) (hereinafter, referred to as a “virtual reality system (VR-system)” and a “mixed reality system (MR-system)” respectively) generally perform processing utilizing position/posture information in a predetermined part of a player. For example, a position/posture sensor is attached to the player's hand, the position/posture information is obtained, and a virtual reality computer graphics (CG) object is displayed in a position of the player's hand, thereby the player feels as if a virtual-reality object exists in the position of the hand (e.g. on the hand).

The mixed reality system produces realism of virtual reality object in real space by overlaying a video image of real world and a CG (CG made by three-dimensional modeling) each other, positioning the both images with each other and displaying them.

As an apparatus for position/posture detection, FASTRAK (product name) by Polhemus, Inc. in the United States is known. This is a magnetic type position/posture detection apparatus having a magnetic emission device and a magnetic reception device (position/posture sensor). The position/posture sensor receives a magnetic wave emitted from the magnetic emission device to detect a position and a posture. The position/posture sensor is a small solid device of one-centimeter square. The sensor detects the spatial position (XYZ coordinates) and posture (roll, pitch and yaw) of the sensor. Conventionally, when the position/posture sensor is attached to a hand, the player wears a glove-like tool with the position/posture sensor.

However, as the conventional tool has a glove-like shape, most part of the hand is covered with the tool and the outlook of the tool causes an unnatural feeling. Especially when the tool is used in a mixed reality apparatus, as the player directly sees a video image of the hand, a visual problem occurs if the glove with the position/posture sensor is large. Further, the player cannot observe the hand itself.

To mitigate the above problems, the area of tool covering the hand may be reduced, however, attachment of the sensor becomes unstable, which increases measurement errors.

Further, in some mixed reality systems, a marker is attached to a real object, and the marker is image-recognized, thereby a CG image is overlay-displayed in the position of the marker. If the position/posture sensor and the marker are attached to the player's hand in such mixed reality system, the position/posture information detected by the position/posture sensor and the position/posture information obtained by recognition of the marker can be utilized in determination of the position of CG overlay display. This improves positioning accuracy.

The marker has a particular geometric shape, a particular color, or a pattern of combination of plural colors, for assisting image recognition. However, as the marker itself is also clearly recognizable for the observer, the marker in this mixed reality system provides an unnatural feeling to the observer.

On the other hand, in the virtual reality system and mixed reality system, sound is also important element as well as image. However, in the conventional systems, sound is reproduced from headphones which the observer wears, an external speaker or the like, regardless of the display position of virtual reality image. For example, even though a virtual image of explosion is displayed on a palm, the sound of explosion is reproduced from another place, which reduces realism. That is, there has been no virtual reality system or mixed reality system which reproduces sound related to a virtual reality image in the display position.

For example, if the display position (display portion) of virtual reality image is previously determined, a speaker may be attached to the position, however, actually, various problems occur. To display a virtual image in a position on the observer's hand and reproduce sound related to the virtual reality image in the display position, the speaker must be attached to the observer's hand. In this case, the speaker and the position/posture sensor are attached in proximity to each other. However, if a speaker using a magnet, a coil and the like is attached in the proximity of the magnetic position/posture sensor, the speaker influences the position/posture sensor and degrades the measurement accuracy.

In addition, as the speaker generally has metal parts, the metal pieces existing between the position/posture sensor as a magnetic reception device and the magnetic emission device degrade the measurement accuracy. Accordingly, there is a problem in attachment of the speaker in the proximity of the position/posture sensor

### SUMMARY OF THE INVENTION

The present invention has been made in view of the above conventional art, and has its object to enable attachment of the position/posture sensor and the speaker used in a virtual reality apparatus, a mixed reality apparatus and the like, in an appropriate state.

According to the present invention, a sensor attachment apparatus for at least attaching a sensor for detecting a position/posture of a hand, used in a virtual reality apparatus, a mixed reality apparatus or the like, comprising a first ring to which said sensor is attached, and a second ring to which a speaker is attached, wherein the first and second rings are connected by a band-shaped connection member.

Further objects, features and advantages of the present invention will become apparent from the following detailed description of embodiments of the present invention with reference to the accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an external view of a sensor attachment tool according to an embodiment of the present invention;

FIG. 2 is a developed view of the sensor attachment tool in FIG. 1;

FIG. 3 is a perspective view of the sensor attachment tool in FIG. 1 attached to a hand (on the palm side);

FIG. 4 is a perspective view of the sensor attachment tool in FIG. 1 attached to the hand (on the back side);

FIG. 5 is a perspective view of a marker attached to the hand on the palm side; and

FIG. 6 is a perspective view of a marker attached to the hand on the back side.

### DETAILED DESCRIPTION OF THE PREFERRED EMBODIMENT

A preferred embodiment of the present invention will now be described in detail in accordance with the accompanying drawings.

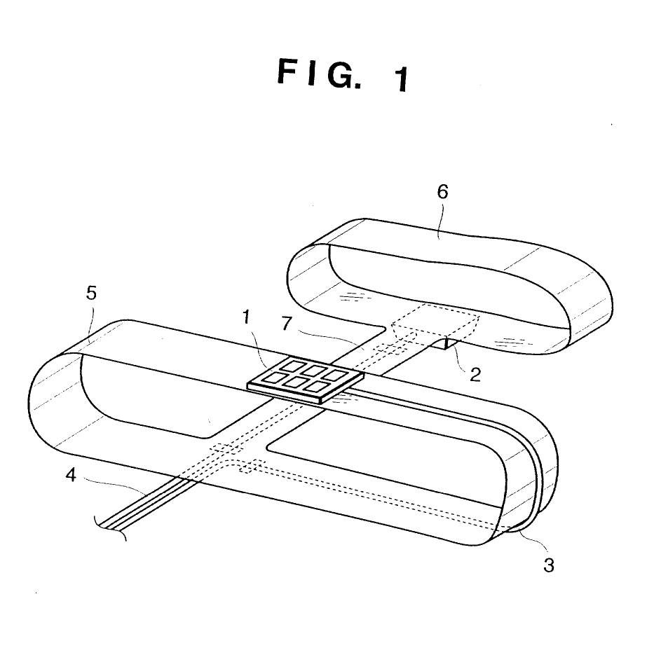

FIG. 1 is an external view of a sensor attachment tool (device) according to an embodiment of the present invention. The sensor attachment tool is made of extendable rubber-like material (material of wet suit or the like). A position/posture sensor and a speaker is fixed to the material by adhesive or sewing. Note that the extendable material does not necessarily have extensibility, but a non-extendable fabric having gathers, in which extendable material such as rubber thread is woven, may be used.

In FIG. 1, reference numeral 1 denotes a speaker; 2, a position/posture sensor; 3, a speaker cable; 4, a sensor cable; 5, a speaker attachment member as a ring-shaped portion to which the speaker 1 is attached; 6, a sensor attachment member as a ring-shaped portion to which the position/posture sensor 2 is attached; and 7, a connection member which connects these portions 5 and 6 with each other.

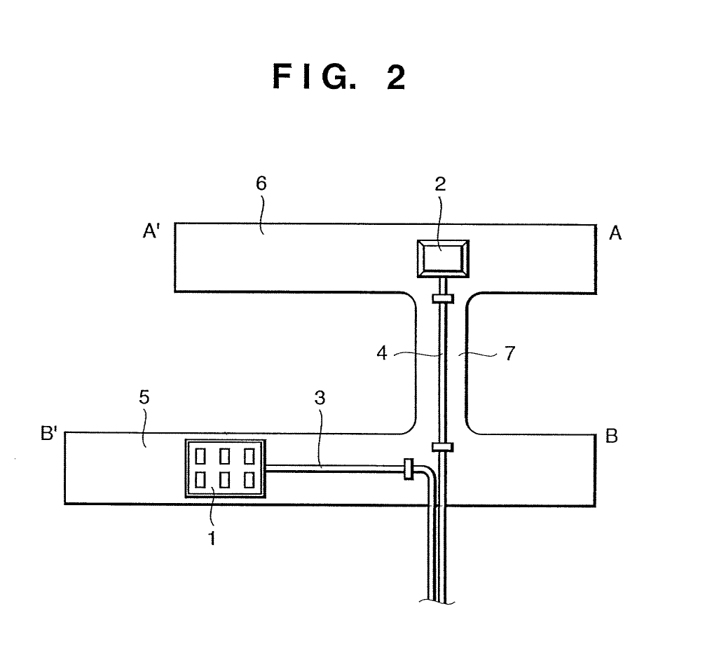

FIG. 2 is a developed view of the sensor attachment tool in FIG. 1. In FIG. 2, portions A and A′ are connected with each other, and portions B and B′ are connected with each other, thereby the shape as shown in FIG. 1 is formed. Note that FIG. 2 shows the developed form for convenience of explanation, but does not necessarily mean that the portions A and A′ and the portions B and B′ are attached with each other in a manufacturing process.

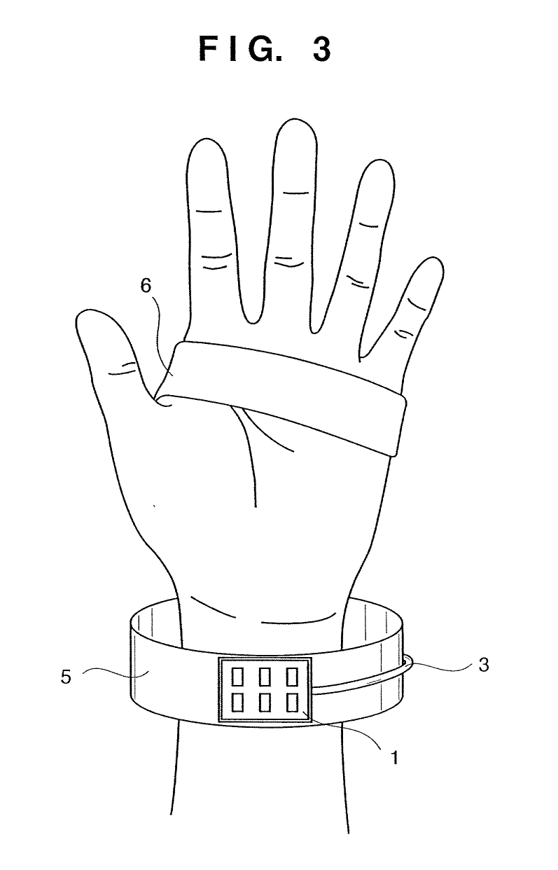

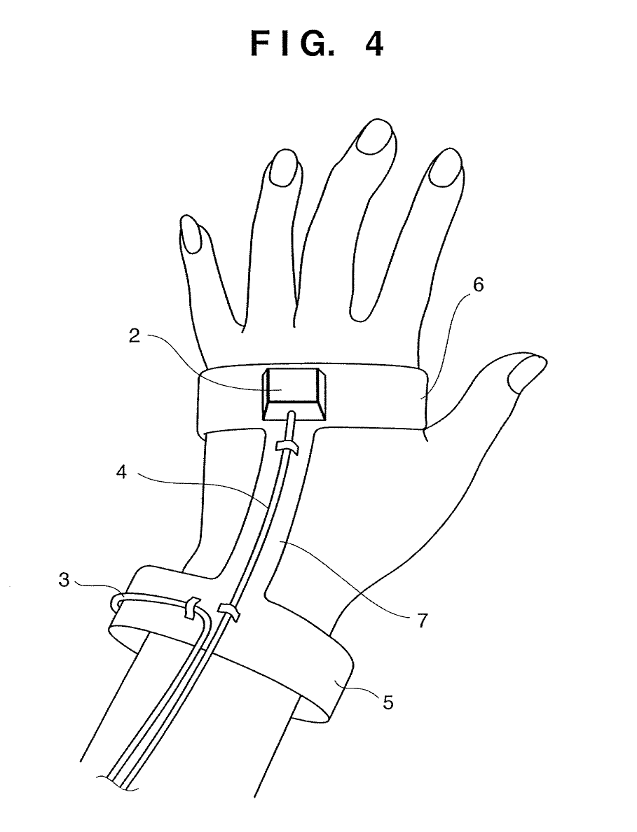

FIGS. 3 and 4 show the sensor attachment tool attached to a hand. FIG. 3 shows the tool viewed from the palm side. The speaker 1 is positioned on the wrist. FIG. 4 shows the tool viewed from the back side. The position/posture sensor 2 is positioned on the back.

In this manner, in the sensor attachment tool, the ring-shaped sensor attachment member 6 and the ring-shaped speaker attachment member 5 are connected with each other by the connection member 7. In this arrangement, the position/posture sensor can be reliably fixed on the hand in spite of small area of the attachment member 6 covering the hand.

Further, as the speaker 1 is positioned on the wrist and the position/posture sensor 1 is positioned on the hand, the distance between the speaker 1 and the position/posture sensor 2 is increased. Further, as the speaker 1 is provided on the palm side and the position/posture sensor 2 is provided on the back side, the distance between the speaker 1 and the sensor 2 is further increased. In this manner, as the position/posture sensor 2 is away from the speaker 1, the ill effects by magnetic influence and metal parts of the speaker 1 on the position/posture sensor 2 can be avoided, and the measurement errors by the position/posture sensor 2 can be reduced.

An attachment procedure is simple. First, the player inserts his/her hand into the speaker attachment member 5 to the wrist, then pass the hand into the sensor attachment member 6 to the palm.

As shown in FIGS. 2 and 3, the speaker 1 and the position/posture sensor 2 are connected to the speaker cable 3 and the sensor cable 4, respectively, and these speaker cable 3 and the sensor cable 4 are sewed on appropriate positions of the sensor attachment tool main body, thus integrally mounted thereon. Especially, the sensor cable 4 is also fixed to the position of the speaker attachment member 5 such that the cable does not directly hang from the position/posture sensor 2. Accordingly, even if the sensor cable 4 sways or is pulled, the shock is absorbed in a portion fixed to the speaker attachment member 5, thereby the attachment portion of the position/posture sensor 2 is prevented from swaying.

Note that the ring size of the sensor attachment member 6 and that of the speaker attachment member 5 are different. The sensor attachment member 6 has a size about the perimeter of the palm such that the position/posture sensor 2 can be tightly fixed on the hand upon attachment of the attachment member 6 around the hand. The speaker attachment member 5 has the next larger ring size than the perimeter of the wrist such that the attachment member 5 can be slided freely on the wrist. Accordingly, when the wrist is bent and straightened, the speaker 5 slides on the wrist and does not pull the connection member 7 and the sensor attachment member 6. Thus, as the speaker attachment member 5 does not apply an excess force to the sensor fixing portion, it does not cause positional shift of the position/posture sensor 2, or does not disconnect the sensor cable 4 from the position/posture sensor 2.

Further, as the speaker 1 is positioned on the wrist, when the player looks at the hand and sees a CG-overlaid video image on the hand, the direction from which sound is emitted is close to the position/posture sensor 2 since the wrist is positioned between the player's viewpoint and the position of the CG (the position of the position/posture sensor 2).

Further, in a case where the magnetic emission device for the position/posture sensor 2 is positioned in front of the player, as the player's wrist is not positioned between the position/posture sensor 2 and the magnetic emission device, the metal parts of the speaker 1 have no ill effect on the position/posture sensor 2 by fixing the speaker 1 to the position of the wrist.

As the speaker 1 vibrates when emitting sound, it can provides vibration to the player's wrist by emitting sound. For example, in a case where a CG image of collision is displayed on the palm, if sound of collision is emitted from the speaker 1, the sound of emission auditorily comes from the hand where the collision has occurred, and further, the vibration is also transmitted to the hand. In MR and VR systems, as the feel of CG-displayed object cannot be obtained, this advantage that the player can experience the vibration corresponding to the CG is important.

As the material of the sensor attachment tool main body has extensibility to some degree, the sensor attachment member can be extended upon attachment, in correspondence with difference in palm sizes. Further, it may be arranged such that in the developed view of FIG. 2, the portions A and A′ are not connected but they are removably engaged by hook-and-loop fasteners or the like, and regardless of the player's hand size, the sensor attachment tool can be always attached to the hand with appropriate tightness. Note that in this case, the speaker attachment member 5 has a size larger than that of the perimeter of the wrist.

In this tool, as the speaker, a piezoelectric speaker may be used in place of the general magnetic coil type speaker. As the magnetic position/posture sensor does not greatly influence the piezoelectric speaker, this speaker can be preferably used in the proximity of the position/posture sensor.

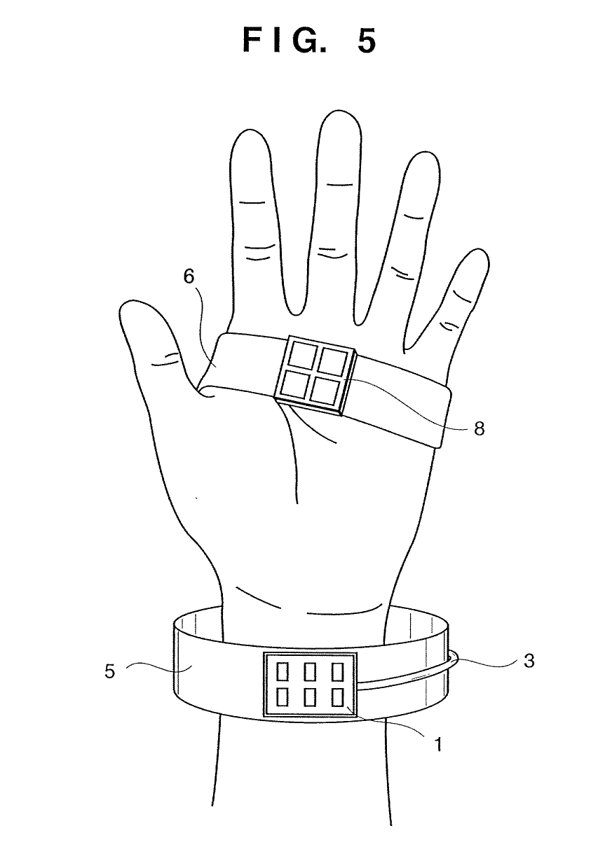

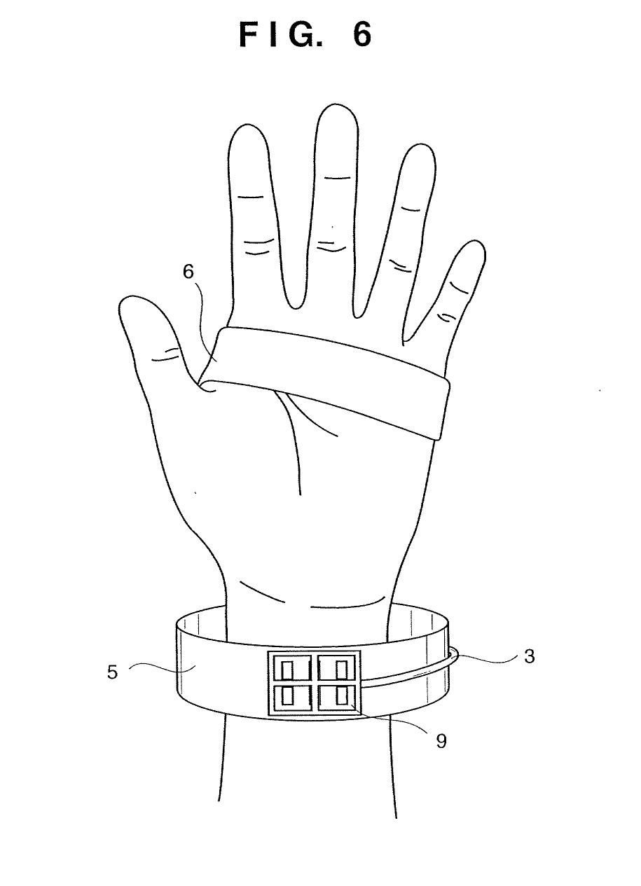

Further, in a case where the sensor attachment tool is used in a system for determining the position of a hand by image recognition, a marker (particular figure, color or the like) as a target of image recognition must be attached to the hand. As shown in FIG. 5, a marker 8 may be attached to the sensor attachment member 6 on the palm side. Further, the speaker 1 itself can be utilized as a marker 9 as shown in FIG. 6. In this case, if the surface of the speaker 1 is provided with an image-recognizable pattern by painting the outline of the speaker 1 or the like in a particular color, the position/posture of the speaker 1 can be recognized.

In FIG. 5, as the marker 8 having a particular appearance appears on the palm, the appearance of the hand is impaired. However, in FIG. 6, as a marker 9 is placed on the surface of the speaker 1, the marker can be set without greatly impairing the appearance of the hand.

In the case of FIG. 6, the position/posture of the palm itself cannot be directly image-recognized, however, as the relative position of the palm to the wrist is known, the position/posture of the palm can be obtained by recognition of the position/posture of the speaker 1.

Further, in an MR system, the speaker 1 can be seemingly hidden by overlay-displaying some CG in the position of the speaker 1.

Note that the present invention is not limited to the above embodiment, but applicable to other position/posture sensors than the magnetic type sensor, such as a ultrasonic type position/posture sensor. Further, if non-magnetic position/posture sensor and speaker are employed, the both position/posture sensor and the speaker may be positioned on the palm side or the back side.

As described above, according to the present invention, a position/posture sensor and a speaker used in a virtual reality system, a mixed reality system and the like can be attached to a hand in a preferable state.

The present invention is not limited to the above embodiments and various changes and modifications can be made within the sprit and scope of the present invention. Therefore, to apprise the public of the scope of the present invention the following claims are made.

What is claimed is:

1. A sensor attachment apparatus for at least attaching a sensor for detecting a position/posture of a hand, used in a virtual reality apparatus, a mixed reality apparatus or the like, comprising:
a first ring to which said sensor is attached; and
a second ring to which a speaker is attached;
wherein said first and second rings are connected by a band-shaped connection member.

2. The sensor attachment apparatus according to claim 1, wherein at least said first ring comprises an extensible material.

3. The sensor attachment apparatus according to claim 1, wherein said second ring and said connection member comprise an extensible material.

4. The sensor attachment apparatus according to claim 1, wherein diameters of said first and second rings are defined so as to attach said first ring in a position of the hand, and said second ring in a position of a wrist,
and wherein the diameter of said second ring is greater than that of the wrist.

5. The sensor attachment apparatus according to claim 1, wherein said sensor and said speaker are provided on opposite palm side and back side of the hand.

6. The sensor attachment apparatus according to claim 1, wherein said sensor and said speaker are respectively connected to a cable, and wherein the cable connected to said sensor is fixed by said second ring.

7. The sensor attachment apparatus according to claim 1, wherein said sensor and said speaker are of magnetic type.

8. The sensor attachment apparatus according to claim 1, wherein said sensor attachment apparatus has a marker for position detection.

9. The sensor attachment apparatus according to claim 1, wherein said marker is attached to a position opposite to an attachment position of said sensor of said first ring.
